(19) United States
(12) Patent Application Publication
(10) Pub. No.: US 2006/0219814 A1
(43) Pub. Date: Oct. 5, 2006

(54) Nebulisation venturi and device comprising the same

(75) Inventor: Karim Benalikhoudja, Mauguio (FR)

Correspondence Address: EGBERT LAW OFFICES, 412 MAIN STREET, 7TH FLOOR, HOUSTON, TX, 77002, US

(73) Assignee: Prolitec, S.A., Paris (FR)

(21) Appl. No.: 10/548,767

(22) PCT Filed: Mar. 11, 2004
(86) PCT No.: PCT/EP04/50294

§ 371 Date: May 2, 2006

(30) Foreign Application Priority Data
Mar. 11, 2003 (FR) 0303203

(51) Int. Cl. A62C 13/62

(52) U.S. Cl. 239/340

(57) ABSTRACT

The nebulisation venturi includes a liquid supply duct and compressed air supply duct, each duct having a nozzle opening in the nebulisation zone in which the air arriving under pressure from the supply duct nebulises the liquid coming from the liquid supply duct. The venturi includes a regulator for the relative position of the liquid supply duct nozzle with relation to the compressed air supply duct nozzle. The regulator can adjust at least the longitudinal position of the liquid supply nozzle and/or the angular position of the liquid supply nozzle. The venturi preferably includes a supply duct for free air with a nozzle in the nebulisation zone and an opening to the outside.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

This invention concerns a nebulization venturi and a device comprising same.

It applies in particular to liquid diffusion devices, for example to the diffusion of perfumes, liquid fuels, etc.

### BACKGROUND OF THE INVENTION

The first goal of this invention is to achieve fine particles of liquid scattered into the air.

It is reminded that nebulization is meant when the size of the liquid particles is less than one micron, and atomization whenever their size is between 1 and 10 microns approximately, and fogging when their size is larger than approx. 10 microns.

Nebulization venturi are known of in which a pressurized air jet sucks, through the Venturi effect, a liquid to be sprayed and produces the diffusion of said liquid in the form of liquid particles. Each of these venturi is made by machining one or more metallic parts making up the body of the venturi. These venturi show fabrication variations such that the orientation of the nebulized liquid particle stream and the nebulized liquid particle diffusion angle are not identical for the various venturi. In addition, there is no nebulization venturi that nebulizes with a constant size of nebulized liquid particles. Thus, in the venturi outgoing stream, a significant proportion of large particles is found, that requires the presence of specific means to trap them.

Finally, the only adjustable parameter with such venturi is the pressure of the air injected into the venturi.

### BRIEF SUMMARY OF THE INVENTION

This invention intends to remedy these disadvantages.

To that effect, this invention concerns, under a first aspect, a nebulization venturi comprising a liquid delivery conduit and a liquid intake conduit and a pressurized air intake conduit, both conduits each provided with at least one nozzle ending toward the nebulization zone in which the air under pressure coming from the air intake conduit nebulizes the liquid coming from the liquid delivery conduit, characterized in that it comprises an adjusting means of the position of the liquid delivery conduit in relation to the pressurized air intake conduit nozzle.

Through these arrangements, good reproducibility of fabrication is achieved since the adjustment of the liquid delivery conduit makes it possible to compensate, at least partially, for the fabrication variations and to adapt the nebulized liquid particle flow to each use.

According to special characteristics, the adjusting means is designed to adjust at least the longitudinal position of the liquid intake nozzle along the axis of the liquid delivery conduit.

Through these arrangements, at least the average angle of diffusion of the nebulized liquid particles can be adjusted.

According to special characteristics, the liquid intake nozzle does not have revolution symmetry in relation to the liquid delivery conduit axis and the adjusting means is designed to adjust at least the angular position of the liquid intake nozzle in relation to the liquid delivery conduit axis.

Through these arrangements, the rotation of this conduit makes it possible to vary the venturi operation, venturi output and size of the nebulized particles.

According to special characteristics, the venturi comprises a free air intake conduit provided with a nozzle in the nebulization zone and an open air opening.

Through these arrangements, the quantity of air to be injected is reduced and the operation of the venturi is thus more economical. The inventor, indeed, discovered that in addition to the air injected by the nozzle on the air intake conduit, air coming from the free air intake conduit participated in the liquid nebulization or at least significantly increased the nebulisate output. The venturi under this invention can thus operate with a small size compressor, small power usage, supplying a small flow of pressurized air, said air flow being supplemented by the additional flow coming from the free air intake conduit.

According to special characteristics, the venturi has a taper downstream of the nebulization zone.

Through these arrangements, the flow of nebulized liquid particles is dispersed in the tapered nozzle.

This invention concerns also a nebulization device comprising a venturi, such as the one briefly described above.

According to special characteristics, the device comprises in addition a diaphragm placed at the outlet of the nebulization zone and designed to retain the nebulized liquid particles located in the lateral parts of the stream of particles coming out of the nebulization zone.

Through these arrangements, the larger nebulized liquid particles located in the periphery of the flow of nebulized liquid particles are retained by the diaphragm and, possibly recovered in the container of liquid to be nebulized.

According to special characteristics, the venturi comprises an air suction conduit provided with a nozzle in the nebulization zone and the device comprises at another opening of the air suction conduit, a negative pressure sensor and a processing means of a signal coming from said sensor and representative of the negative pressure inside the suction conduit.

According to another characteristic of the invention, the negative pressure sensor totally blanks the air suction conduit, but as an alternative, the blanking can be only partial, with the body of the pressure sensor then creating a more or less significant loss of charge.

Through these arrangements, the negative pressure sensor makes it possible to determine the absence of liquid at the liquid delivery conduit in the nebulization zone. To that effect, the inventor discovered that when there is no more liquid in this nozzle, the value of the negative pressure sensed by the pressure sensor is different from the value of the negative pressure when said nozzle contains liquid to be nebulized. It is to be noted that the air suction conduit and the free air intake conduit briefly described above can be confused.

The signal processing means can then generate a sound, visual or wire/non-wire remotely transmitted alarm and/or cause power cutoff to the air compressor supplying pressurized air to the nozzle.

According to special characteristics, the liquid suction conduit comprises also an open air opening. Thus, the liquid suction conduit offers the advantages of the free air intake conduit briefly described above. i.e., the quantity of air to be injected is reduced and the operation of the venturi thus more economical.

### BRIEF DESCRIPTION OF THE SEVERAL VIEWS OF THE DRAWINGS

Other advantages, goals and characteristics of this invention will become apparent from the description to follow, done based on the attached drawings.

FIG. 1 shows a cross-sectional view of a venturi according to a first special embodiment of a first aspect of this invention; and FIG. 1a shows at an enlarged scale the details of FIG. 1.

FIG. 2 shows a cross-sectional view of a venturi according to a second special embodiment of a first aspect of this invention.

FIG. 3 shows a cross-sectional view of a venturi according to a third embodiment of a first aspect of this invention.

FIG. 4 shows a cross-sectional view of a venturi according to a fourth special embodiment of a first aspect of this invention.

FIG. 5 shows a partial perspective view of a venturi according to another special embodiment of the first aspect of this invention.

FIGS. 6 and 7 show cross-sectional views of a special embodiment of a nebulization device according to another aspect of this invention.

FIG. 8 is a detail sectional view of FIG. 6.

FIG. 9 shows schematic view of a nebulization device comprising a means of alarm generation.

FIG. 10 is a schematic view of a representation of a process flowchart of a nebulization device according to one special embodiment of a process that is the subject of one aspect of this invention.

FIG. 11 is a schematic view of a representation of a shutter adaptable to the embodiments shown in FIGS. 6 through 9.

FIG. 12 is a schematic view of a representation of an alternative shape for the liquid delivery conduit nozzle that can be used in each embodiment of this invention.

FIGS. 13 and 14 are perspective views of an open (FIG. 13) and closed (FIG. 14) case intended to receive the device under the invention.

### DETAILED DESCRIPTION OF THE INVENTION

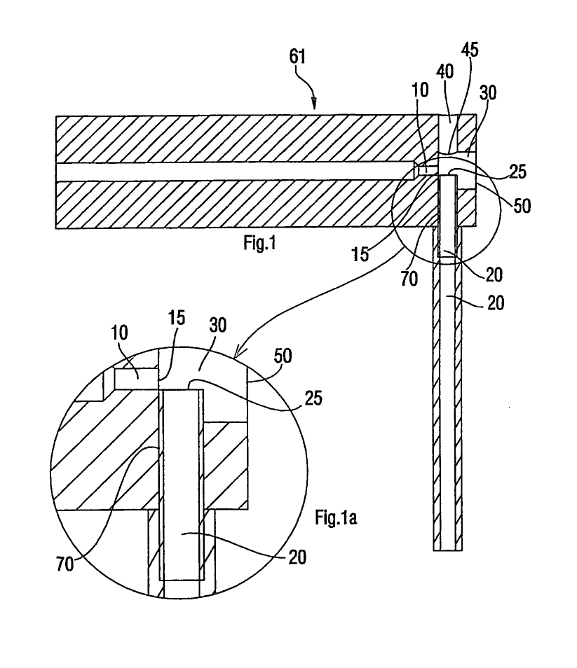

In each of FIGS. 1 through 4, a venturi 61 through 64 respectively can be seen, each comprising a venturi body, an air intake conduit 10, a delivery conduit for the liquid to be nebulized 20, a nebulization zone 30 in which are located a nozzle 15 of the air intake conduit 10 and a nozzle 25 of the liquid delivery conduit 20, a free air conduit 40 provided with a nozzle 45 in the nebulization zone 30, the nebulization zone being formed in the venturi body and the various conduits entering said body, more specifically said conduits fitting into borings made in the venturi body, proper sealing being achieved between the outside cylindrical faces of the conduits and the cylindrical faces of the corresponding borings. One can see that the conduit 20 enters into the nebulization zone 30 that is formed by a cylindrical chamber. One can see that the conduit 20 can be made of a containing part and of a contained part mounted in the containing part with a tight fit or slightly tight fit, the nozzle 25 being provided for at the end of the contained part. The type of fit can allow for the sliding of the contained part inside the containing part or prevent it.

One can also see that the nozzle 45 is in a geometric plane perpendicular to the longitudinal axis of the conduit 40 and that the nozzle 15 is arranged according to a geometric plane perpendicular to the longitudinal axis of the conduit 10. One can also see that the longitudinal axes of the conduits 10, 20 and 40 are secant, that the longitudinal axis of the conduit 10 is perpendicular to the longitudinal axes of the conduits 40 and 20. One can also see that the conduits 40 and 20 are axially aligned.

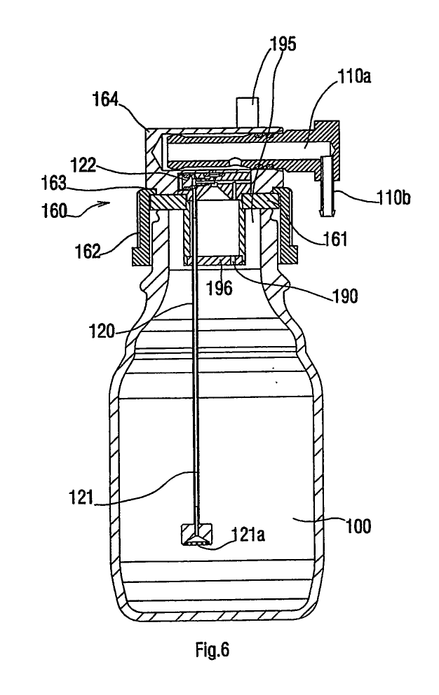

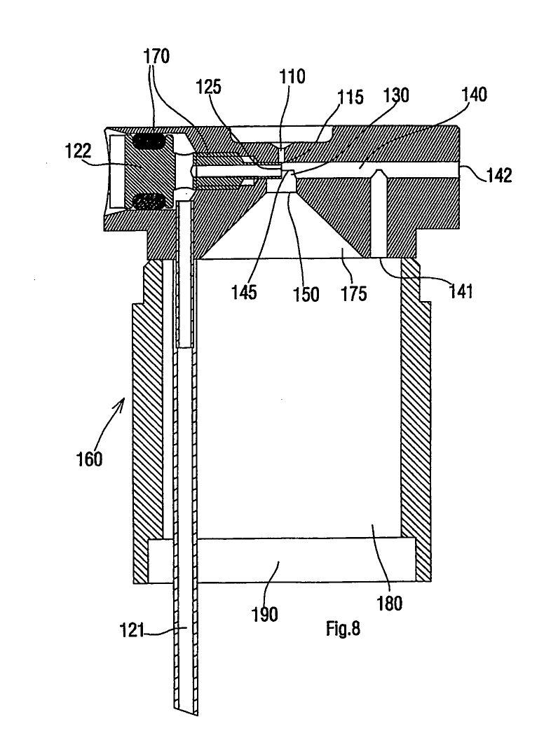

The air intake conduit 10 is connected to a compressor (FIG. 9) that supplies air under pressure, e.g., equal to between one and ten times the atmospheric pressure. The liquid delivery conduit 20 is connected at one end to a container of liquid to be nebulized (FIGS. 6, 7 and 9). In the nebulization zone 30, the nozzle 15 of the air intake conduit 10 and the nozzle 25 of the liquid delivery conduit 20 are respectively positioned so that through Venturi effect, the liquid either is sucked into the nebulization zone 30 where the air flow coming out of the nozzle causes the generation of a flow of nebulized liquid particles, directed toward an outlet 50 of the nebulization zone 30, in a well-known manner.

It can be noted that the venturi 61 through 64 has an adjusting means 70 of the position of the nozzle 25 on the liquid delivery conduit 20. Adjustment can be achieved through longitudinal sliding and/or rotation of the liquid delivery conduit 20 in the venturi 61 through 64. To that effect, the liquid delivery conduit can be provided with a threaded section and the boring in the venturi body designed to receive said conduit shall be tapped, the conduit thread matching the boring tap. With such solution, the axial displacement of the conduit cannot be dissociated from its rotation. According to an alternative embodiment, the liquid suction conduit 20 and the corresponding boring are smooth, which allows for longitudinal adjustment of the conduit independently from its rotational adjustment.

Adjustment of the position of the nozzle 25, using the adjusting means 70, permits to vary the operating parameters of the venturi 61 through 64, to compensate at least partially for the fabrication variations and to adapt the stream of nebulized liquid particles to each use. By moving longitudinally the nozzle 25, at least the average diffusion angle of the nebulized liquid particles is adjusted in relation to the air intake conduit axis 10.

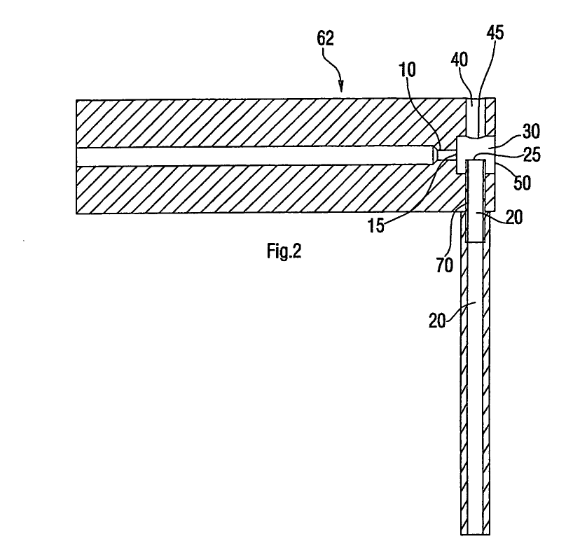

In FIG. 1, the nozzles 15 and 25 touch, except for the thickness of conduit 25. In FIG. 2, on the other hand, the nozzle 25 is apart from the nozzle 15 by a distance of the same order of magnitude as the diameter of the nozzle 25, i.e., between half and three times this diameter.

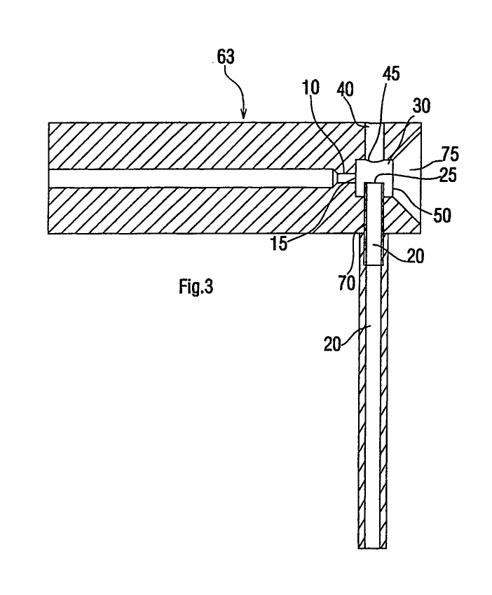

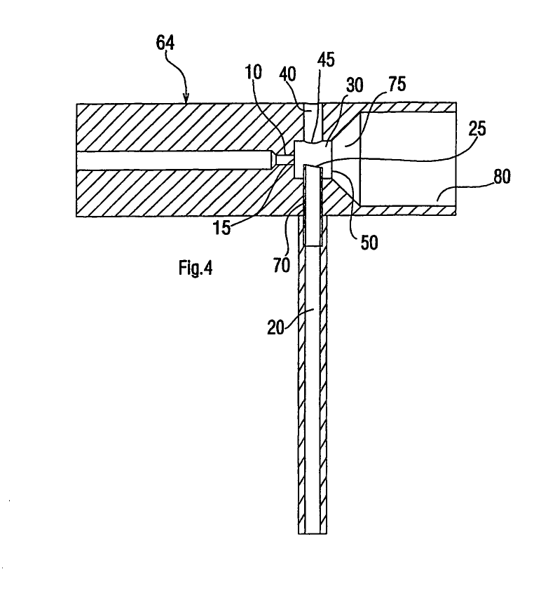

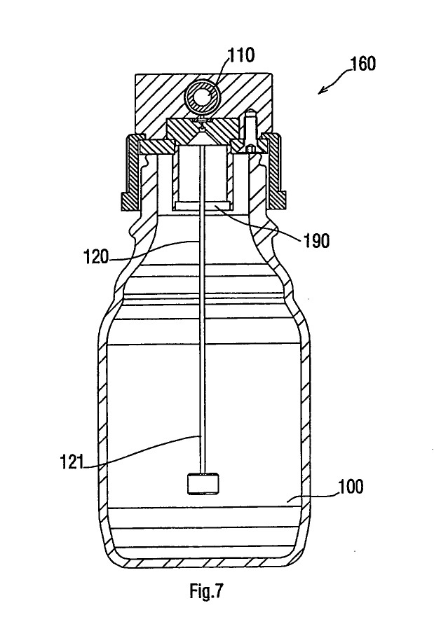

In FIG. 3, the same elements as in FIG. 2 can be noted, plus a taper 75 extending axially the nebulization zone 30. In FIG. 4, the same elements as in FIG. 3 can be noted, plus an extension of the taper 75 in the form of a cylindrical chamber 80 acting as diaphragm, i.e., laterally retaining the stream of nebulized liquid particles. Thus, the larger particles that are generally located in the lateral parts of this stream, settle on the cylindrical lateral surface of the chamber 80 and flow under the effect of gravity to be recovered either in the nebulization zone, or in the container of the liquid to be nebulized (see FIGS. 6 through 8).

In FIG. 1 through 3 it can be noted that the nozzles 25 and 45 are arranged according to parallel geometrical planes, and that the nozzle 25 is in a geometrical plane perpendicular to the longitudinal axis of the conduit 20, while in FIG. 4, it can be noted that the liquid delivery nozzle 25 is not provided with revolution symmetry in relation to the liquid delivery conduit axis: the plane of the nozzle 25 shows, in relation to the longitudinal axis of the conduit 25, an angle different from 90 degrees. In alternative solutions, the absence of revolution symmetry is reflected by a non-circular shape of the conduit 20. The adjusting means 70 is designed to adjust at least the angular position of the liquid delivery nozzle 25, in relation to the liquid delivery conduit 20. The rotation of this conduit 20 permits to vary the operation of the venturi 64.

Although not shown in the figures, alternatively, the adjusting means 70 of the position of the nozzle 25 also permits to adjust the distance between said nozzle 25 and the nozzle 15 along the axis of nozzle 15, to adjust the distance between said nozzle 25 and the axis of the nozzle 15 and/or to adjust the angle between the axes of nozzles 15 and 25, according to mechanical means known as such.

In each of FIGS. 1 through 4, one can note the free air intake conduit 40 that ends in the nebulization zone 30, through the nozzle 45 and for which another opening is in the open air, e.g., in the container of the liquid to be nebulized (see FIGS. 6 through 8). The shape and/or position of nozzle 45 of the free air intake conduit in the nebulization zone 30 cause the suction of free air into this area, e.g., through the venturi effect, or through the effect of the negative pressure generated on the lateral parts of the nebulization zone 30 through the air flow injected by nozzle 15. The inventor noted that the presence of the free air intake conduit 40 made it possible to increase the efficiency of each venturi 61 through 64, compared to a similar venturi not provided with this free air intake conduit 40.

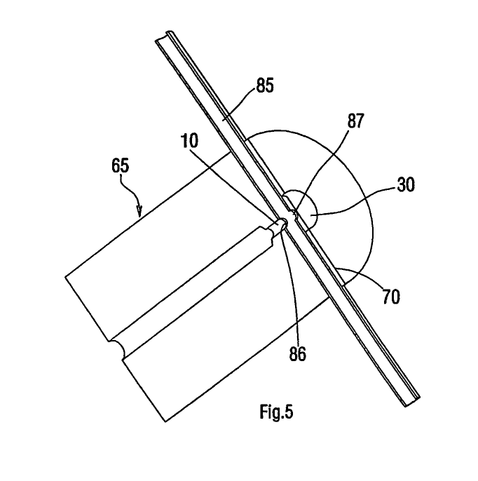

In FIG. 5, a venturi 65 can be noted that comprises an air intake conduit 10, a cylindrical conduit 85 for delivery of the liquid to be nebulized on one hand, and intake of free air on the other hand, a nebulization zone 30 comprising a nozzle 15 of the air intake conduit 10 and two openings 86 and 87 of conduit 85. The conduit 85 is designed to slide in a cylindrical boring made in the body of venturi 65. In this manner, the adjusting means 70, consisting of this boring, makes it possible to slide conduit 85 both in rotation in relation to its axis and in translation along its axis, which makes it possible to vary the position of openings 86 and 87 in relation to nozzle 15 and thus constitutes two adjusting parameters of the operation of venturi 65. In addition to the openings 86 and 87, conduits 85 has at one end an open air opening and at the other end an opening in a container of the liquid to be nebulized

The openings 86 and 87 are circular and have diameters practically equal to the diameter of nozzle 15. They are placed symmetrically in relation to the longitudinal axis of conduit 85. They are thus diametrically opposite.

FIGS. 6 through 8 show a container of the liquid to be nebulized 100, a delivery conduit of the liquid to be nebulized 120 consisting of a hollow rod 121 plunging into the liquid contained in the container 100 and of a secondary conduit 122 inserted into a venturi 160, said secondary conduit being in a communication relation with the conduit 120. The venturi 160 rests on the rim of the container through a centering flange 161, either independent or rooted in the venturi body. A pilferproof ring 162 is positioned around the upper part of the container and through a locking collar 163 in its upper part rests against the centering flange 161. This pilferproof ring 162 is attached in a non-removable fashion on the container. In addition, the venturi 160 is covered with a cap 164 in which an air intake conduit 110a and a nebulisate discharge conduit 195 are formed.

The air intake conduit 110a is appropriately extended by a fitting end 110b that is proof against a source of pressurized air, e.g., the compressed air output of a compressor. This fitting end 110b can be vertical as shown and extend either upward or downward, but said fitting end can also have a horizontal position.

The cap 164 is attached to the centering flange 161 with screws and covers the locking collar 163 on the pilferproof ring 162. Each screw is inserted into a boring through the flange 161 and into a blind tap made in the cap 164. Because of this arrangement, the screw heads are in the inside volume of the container or opposite it and are therefore inaccessible.

Thus, after the pilferproof ring 162 is secured on the container, it is no longer possible to remove the venturi, without destroying the ring and to access the content of the container.

This device can then be single-use and disposable after depletion of the liquid contained in the container.

To reinforce safety by precluding the introduction into the device, and especially into the container, of any foreign matter or liquid before or after complete depletion of the liquid initially contained in the container, the various conduits accessible from outside the device can be equipped with securement means such as check valves and alike.

The venturi 160 comprises an air intake conduit 110 in communication relation with the conduit 110a provided in the cap, the secondary conduit 122, a nebulization zone 130 in which there is a nozzle 115 of the air intake conduit 110 and a nozzle 125 of the liquid delivery conduit 120, an outlet 150 of the nebulization zone 130, an adjusting means 170 of the position of the secondary conduit 122, a taper 175 extending outlet 150 of the nebulization zone and a cylindrical chamber 180 extending the taper. The adjusting means 170 consists of a micrometric pitch screw. The venturi 160 can also have a free air conduit 140 with a nozzle 145 in the nebulization zone 130. This free air conduit will be in communication relation with a through-conduit 140a provided in the cap.

In a preferred design, the conduit for the liquid to be nebulized 121 comprises at its lower end a filter 121a. This filter plunges into the liquid present in the container.

The free air conduit or suction conduit 140 also features:—an opening 142 designed to receive a negative pressure sensor (see FIG. 9).

In the nebulization zone 130, the nozzle 115 of the air intake conduit 110 and the nozzle 125 of the liquid delivery conduit 120 are respectively positioned so that through Venturi effect, the liquid is sucked into the nebulization zone 130 where the air flow coming out of the nozzle 115 causes the generation of a stream of nebulized liquid particles, directed toward the outlet 150 of the nebulization zone 130, in a well-known manner.

The inventor noted that the presence of the free air intake conduit 140 made it possible to increase the output of the venturi 160 compared to an identical venturi not equipped with this free air intake conduit 140. In addition, since the suction conduit sucks air in the chamber 180, part of the stream from the venturi is reinjected into the nebulization zone, which makes it possible to increase the concentration of nebulized liquid particles in the stream leaving the chamber 180.

In a manner characteristic of one aspect of this invention, the escape opening 190 through which the flux coming out of the chamber 180 exits the venturi 160 ends into the liquid container 100 and the liquid container 100 comprises a nebulized liquid particle release opening 195 through which part of the nebulized liquid particles coming from the escape opening 190 exits the container 100 and the nebulization liquid to be diffused in the atmosphere surrounding this nebulization device.

Thus, the larger nebulized liquid particles settle by the effect of gravity or because of their inertia in the container 100 where they join the liquid to be nebulized.

In a preferred design, the escape opening 190 is directed toward the surface of the liquid contained in the container.

FIG. 9 shows a nebulization device 200 comprising the container 100 and venturi 160, a compressor 210, a power supply 220 for the compressor 210, a pressure sensor 230, a processing means 240, an alarm signal generator 250, a sound transmitter 260, an indicating light 270 and a computer network 280.

The pressure sensor 230 is positioned on the opening 142 of the conduit 140 and generates a signal representative of the pressure (or negative pressure) in the lateral parts of the nebulization zone 130. The processing means 240, for example an electronic board (possibly of the microprocessor type), a computer or a threshold circuit, receives the signal transmitted by the pressure sensor 230 and, based on predetermined variation criteria of this signal, causes the generation of alarm signals by the alarm signal generator 250 sent to the sound transmitter 260, indicator 270 and/or computer network 280.

The predetermined criteria are for example:
drop of pressure measured below a threshold level or
drop of pressure by at least 10% measured in less than 5 minutes.

The inventor indeed discovered that when there is no more liquid in the nozzle 125, the value of the negative pressure sensed by the pressure sensor 230 is different from the value of the negative pressure when said nozzle contains liquid to be nebulized. In the embodiment illustrated in FIGS. 6 through 9, the value of the pressure measured is, when there is no more liquid in the nozzle 125, lower than when there is still liquid to be nebulized in the nozzle 125.

The alarm signal generator 250 is designed to command:
the transmittal of sound signals by the sound transmitter 260, consisting for example of a speaker,
the transmittal of visual signals by the indicating light 270, consisting for example of a LED and/or
the transmission of alarm signals by the computer network 280, consisting for example of a wire or non-wire connection connected to a capture board itself connected to a computer system.

The processing means is also designed to cut off the power supply of the compressor 210 when it detects that there is no more liquid to be nebulized.

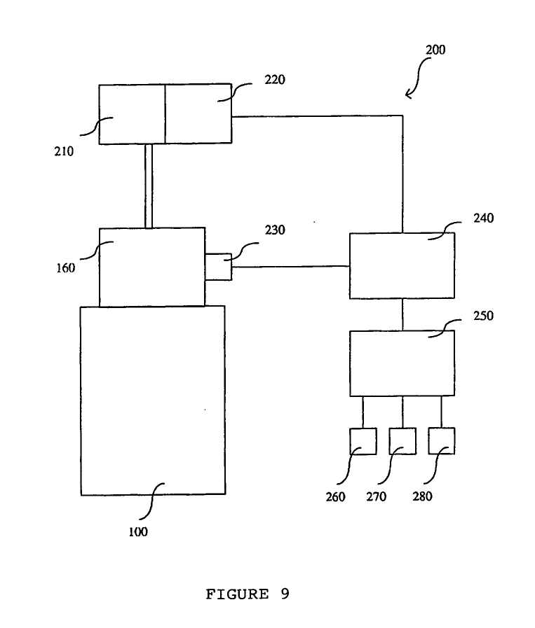

FIG. 10 shows an initialization step 300 during which a venturi is connected to a container of liquid to be nebulized so that the projection by the venturi of nebulized liquid particles is done inside the container.

Then, during step 310, an air compressor is started to cause suction of the liquid to be nebulized into a container.

For each part of the liquid sucked during step 310, an injection step 320 into a nebulization zone then takes place and a projection step 330 of the nebulized liquid particles into said container.

Part of the nebulized liquid particles then exits the container through a release opening during step 340.

In parallel to the steps 320 through 340, part of the air in the container is sucked into a free air conduit, step 350, and injected into the nebulization zone, step 360.

In parallel to the steps 320 through 360, a measurement step 370 is carried out for the pressure in the nebulization zone and a processing step 380 of said measurement.

According to a preferred design, during measurement step 370, the pressure is measured in a suction conduit provided with a nozzle in the nebulization zone, and possibly with an open air opening, for example, in the container.

During the processing step 380, the compressor operation is stopped or an alarm signal is generated whenever the pressure meets predetermined variation criteria, as explained based on FIG. 9.

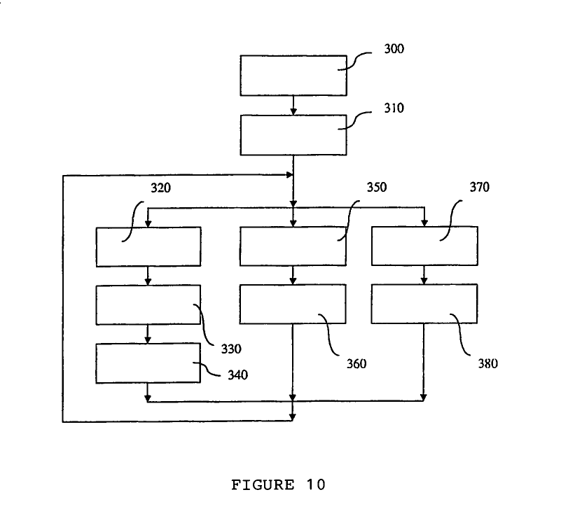

FIG. 11 shows a circular component or diaphragm 196 with three lateral openings 197 that can be inserted into the escape opening 190 preferably in a shoulder provided at the end of this opening, i.e., opposite to the nebulization chamber (see FIG. 6). The function of this circular component is to retain the largest particles of the nebulized liquid so that they form large size drops that fall under the gravity effect into the container 100, which prevents the formation of an emulsion liable to cause oxidation of the liquid to be nebulized.

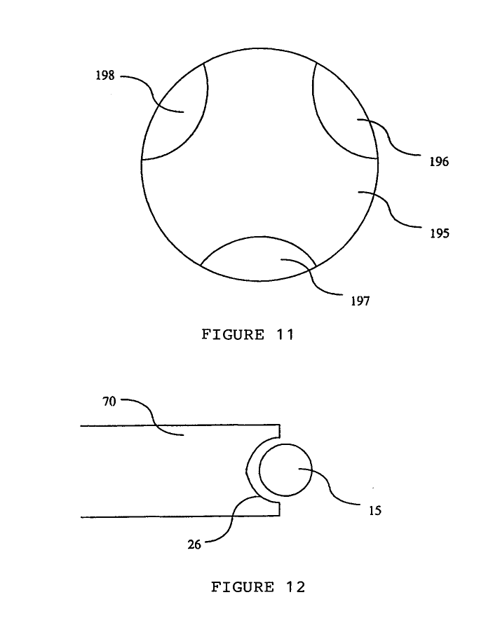

FIG. 12 shows an alternative form 26 of the nozzle 25 (see FIGS. 1 through 4).

In this alternative, the opening of nozzle 25 has a non-plane shape formed by the intersection of the liquid delivery conduit 70 and of a cylinder surrounding the nozzle of the pressurized air intake 10, with the pressurized intake air conduit as axis. The inventor noted that this particular shape 26 allows for good efficiency of the nebulization venturi 61 through 64. Any other shape, for example, triangular can be provided for.

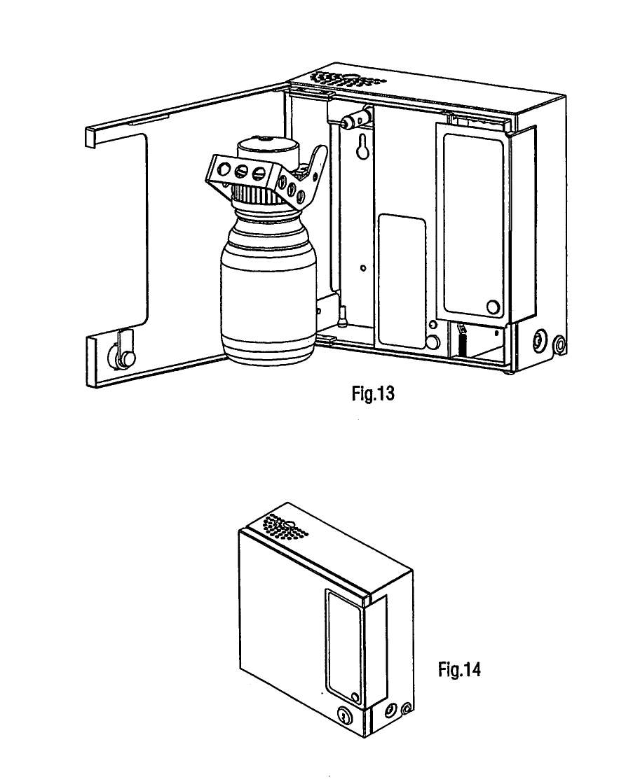

The device as described will be appropriately arranged in a compartmented protective case as shown in FIGS. 13 and 14. As one can see, this case has a closing flap with a lock. One of the compartments of the case shall be designed to receive the device under the invention and another one of the compartments shall be designed to receive the compressed air compressor. The compressor compressed air outlet shall be connected through a flexible or rigid line to a socket secured in the first compartment and designed to receive the cap socket end of the nebulization device. Another compartment shall be provided to receive the device electronics.

In a preferred design, to secure the device inside the case without altering the removability of the device, the latter is equipped with a locking lever designed to work together through pivoting with two anchoring studs mounted in the first compartment.

It is understood that this invention can accommodate any fixtures and alternatives from the field of equivalent techniques without thereby going outside the scope of this invention.

I claim:

1. Venturi comprising
a liquid delivery conduit,
a pressurized air intake conduit, both conduits being comprised of each with at least one nozzle ending toward the nebulization zone in which air under pressure coming from the liquid delivery conduit, and
an adjusting means of the position of the liquid delivery conduit nozzle in relation to the pressurized air intake conduit nozzle.

2. Venturi according to claim 1, wherein said adjusting means is designed to adjust at least the longitudinal position of the liquid intake nozzle along the axis of the liquid delivery conduit.

3. Venturi according to claim 1, wherein a liquid intake nozzle does not have revolution symmetry in relation to the liquid delivery conduit axis and the adjusting means is designed to adjust at least the angular position of the liquid intake nozzle in relation to the liquid delivery conduit axis.

4. Nozzle according to claim 1, further comprising:
a free air intake conduit comprised of a nozzle in the nebulization zone and an open air opening.

5. Venturi according to claim 1, further comprising:
a taper downstream of the nebulization zone.

6. Nebulization device according to claim 1, further comprising:
a venturi.

7. Nebulization device according to claim 6, further comprising:
a diaphragm placed at the outlet of the nebulization zone and designed to retain the nebulized liquid particles located in the lateral parts of the flow of particles coming out of the nebulization zone.

8. Device according to claim 6, wherein said venturi comprises an air suction conduit provided with a nozzle in the nebulization zone; and further comprising:
at another opening of the air suction conduit, a negative pressure sensor; and
a processing means of a signal coming from said sensor and representative of the negative pressure inside the suction conduit.

9. Device according to claim 8, wherein the signal processing means generates a sound, visual or remotely transmitted alarm, or causes electric power cutoff to the air compressor supplying pressurized air to the venturi.

10. Device according to claim 8, wherein said suction conduit comprises an open air opening.
